(19) United States
(12) Patent Application Publication
(10) Pub. No.: US 2009/0227285 A1
(43) Pub. Date: Sep. 10, 2009

(54) CLICK AND PICK VIDEO RECORDING WITH ON-LINE EDITING

(75) Inventors: Orna Bregman-Amitai, Tel-Aviv (IL); Eli Ben-Ami, Herzliya (IL); Julio Arluk, Kfar Saba (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(73) Assignee: SAMSUNG ELECTRONICS CO., LTD., Gyeonggi-do (KR)

(21) Appl. No.: 12/043,263

(22) Filed: Mar. 6, 2008

(51) Int. Cl. H04M 1/00; G11B 27/02

(52) U.S. Cl. 455/556.1; 386/52

(57) ABSTRACT

A digitally-enabled cellular phone device is provided with video recording means and comprises inputs means for recording a first mark relative to the video timeline, said first mark being indicative of the starting period of a segment of video to be assigned a priority value, and means for recording a second mark relative to said video timeline, said second mark being indicative of the end period of said segment of video.

### FIELD OF THE INVENTION

The present invention relates to the field of digitally-enabled cellular phones. More particularly, the invention relates to an efficient method and a device for utilizing the digital capabilities of modern cellular phones, in respect of video and still images, while overcoming limitations resulting from storage constraints and non-dedicated actuators.

### BACKGROUND OF THE INVENTION

Shooting home videos has become a very common operation, more so since video recording apparatus is readily available in a variety of forms, including cellular phones. However, operating such non-dedicated devices efficiently is often difficult, for a number of reasons. First of all, in many cases we only realize that the scene in which we are most interested has happened, after we took a very long video scene, in which we are often not interested. Theoretically, this problem can be solved by editing the video off-line, but in practice this seldom happens with videos shot on the spur of the moment, particularly when using non-dedicated equipment.

Additionally, it is not uncommon to miss the most interesting scene because we stopped recording a previously uninteresting one, or didn't start shooting before it was too late. This is often also the result of problems associated with disk space, particularly when long events are involved and even more particularly when the equipment used his non-dedicated, such as a cellular phone, and therefore the available disk space for video recording is limited. A further problem concerning our desire to extract single images (still images) while shooting a video stream, without stopping video recording.

All the above problems are compounded by the fact that cellular phones, not being dedicated recording devices, must operate using keyboards, buttons and other kinds of actuators, which have other primary functions and have not been specifically designed for video-recording apparatus.

Various professional solutions are available, which enable different levels of control and editing of the video in the recording device. However, all solutions currently available in the art require the use of external computer apparatus and provide only complicated and functionally limited retroactive video clip editing. For instance, NLT markets a professional camera comprising a so-called RetroLoop option. Other professional cameras, such as the JVC DR-DV5000-40 exist, which has a retro loop recording of up to 8 seconds

JP 2002-305706 provides a video recording and reproducing device that can automatically store/erase video data by placing priority on video data having been recorded. Although this solution and is intended for dedicated video recording apparatus, it is limited in the number of priorities that can be assigned.

U.S. Pat. No. 7,088,910 addresses home digital video systems equipped with a storage device, and relates to a method for optimizing the use of available storage space on the storage device. A similar problem is addressed by EP1231786, which relates to an intelligent disk recording and management system that selectively assigns tags to determine the manner and/or priority of recording programs onto a storage device and the priority of maintaining the programs on the storage device once the programs are recorded.

US patent application 2004/0033058 provides a device that records an event before the decision to record is taken. Thus, the system monitors a scene and can shift to a recording mode and capture the previous 30 seconds or so. This is similar to the retro loop option discussed above.

Although the art deals with the handling of digital images in various ways, solutions that have been devised for dedicated recording apparatus, such as video cameras or digital video recording apparatus, are not convenient for use with cellular phones that are provided with digital image recording capabilities, because cellular phones are multifunctional devices which are used constantly by their owner in a variety of ways.

That is therefore a need for a solution that will allow the owner of digitally-enabled cellular phones to exploit their devices in an efficient manner, without detracting from their multifunctional nature. For instance, it would be desirable to provide a solution which would enable the user to edit the video stream and to prioritize scenes even retrospectively, while shooting or watching. It would also be desirable to provide a method and cellular phone device, which enable the user to extract images while recording a video stream, and which would be essentially free from recording constraints due to disc space limitations, which are inherent to cellular phones.

Other objects of the invention will become apparent as this description proceeds.

### SUMMARY OF THE INVENTION

The invention relates to a digitally-enabled cellular phone device, provided with video recording means, comprising inputs means for recording a first mark relative to the video timeline, said first mark being indicative of the starting period of a segment of video to be assigned a priority value, and means for recording a second mark relative to said video timeline, said second mark being indicative of the end period of said segment of video.

According to a preferred embodiment the cellular phone device according to the invention further comprises means for prioritizing a plurality of video streams or frames taken therefrom.

According to another preferred embodiment of the invention, the cellular phone device comprises input means for recording a mark relative to the video timeline, said mark being indicative of at least one frame to be extracted from said stream of video.

In still another preferred embodiment of the invention the mark added to the timeline identifies a frame or a number of frames to be used to generate a still image. In one mode of operation the mark added to the timeline indicates an “immediate” image take. In an alternative mode of operation the mark added to the timeline indicates a “predefined delay”, suitable to identify a still image to be taken, which was recorded at a predetermined time before said mark was added.

### BRIEF DESCRIPTION OF THE DRAWINGS

In the drawings:

FIG. 1 schematically illustrates the fixed number of files in a loop, according to a preferred embodiment of the invention.

### DETAILED DESCRIPTION OF PREFERRED EMBODIMENTS

According to one embodiment of the invention to the invention a GUI (Graphic User Interface) is provided, which allows the user to mark the following events on the video timeline:
Take a still image: the mark added to the timeline can be of different types, such as indicating an “immediate” image take, or a “predefined delay”, indicating that the still image to be taken was recorded at a predetermined time before the mark was added (for instance, two seconds before a button is pressed by the user).
Retroactive scene: a mark can be added to the timeline indicating a predefined delay for the beginning of the scene of interest. Of course, as will be appreciated by the skilled person, an essentially unlimited number of predefined delay marks can be provided, as well as defined by the user, to allow flexibility to the user to define segments of interest. Pressing a predefined button again ends the interval of interest, thus defining the segment of video of interest to the user. These time marks may also mark the priority level of the scene/image. The user may have the option to change priority of the current scene, or even previous scenes.

In an alternative preferred embodiment of the invention the keys of the cellular phone can be use instead of, or in addition in addition to the GUI.

It should be understood that this description is provided with reference to “cellular phones”, but this term should be interpreted in its broadest sense, to include any mobile device that has as one of its primary functions the function of a cellular phone. This will include not only conventional cellular phones but also, for instance, PDAs, provided or not with touch screens.

As will be appreciated by the skilled person, recording a time mark and/or priority info associated with the video timeline can be achieved without affecting the recording process. According to a preferred embodiment of the invention the events marked on the timeline are saved in a memory separate from the one in which the video stream is saved. According to an alternative preferred embodiment of the invention, however, the video and the events are saved in the same memory storage.

In a further embodiment of the invention and automatic marker is provided for marking the beginning and/or the ending of an interesting scene, based on a scene detector, which detects changes in the image seen by recording apparatus. Providing such detectors is well within the scope of the man of the art and is therefore not described herein in detail, for the sake of brevity.

At the end of the recording, post processing utilities using the video editing tools available with many digital cameras and camera phones can be used to extract the still images and the desired video scenes from the long video recording, according to the marks provided on the timeline. If desired, more than one still image can be extracted for a given time mark, to allow the user to select the still image he prefers. This feature may be important if the reaction time of the user is slow, which may result in an inaccurately-positions mark on the timeline.

As will be appreciated by the men of the art, the invention has the advantage that it can exploit hardware already existing in non-dedicated video recording apparatus, such as a cellular phone. The addition of the GUI does not require additional substantial resources and, therefore, can be easily implemented using existing hardware.

In a particularly preferred embodiment of the invention a smart loop recording is carried out on the basis of a prioritization scheme. These preferred embodiment allows to manage the disk space according to the user's priority definitions. In order to achieve the abovementioned results, a double buffer is implemented. As will be apparent to the skilled person from the description to follow, the solution of the invention can be also used for sending video based on keyframes, such as in MPEG-4, or on packets, such as in DMB. Digital Multimedia Broadcasting (DMB) is a digital radio transmission system for sending multimedia (radio, TV, and datacasting) to mobile devices such as mobile phones.

The format is based on MPEG-4.

To illustrate this particularly preferred embodiment, it is defined that the header is saved in a special file and the following stream is always saved by parts in a set of N files (for example N=100). Each part contains part of the movie and starts with a key frame (full information, no prediction) and followed with all the derived frames. Therefore, each file contains data that can be independently decoded using the header info. It should be noted that the file's size is not fixed, but its maximum size can be estimated.

It should be noted that the loop recording requires having at least a minimal number of data parts to be used for recording. This number may be determined by the maximal allowed length of recording scene.

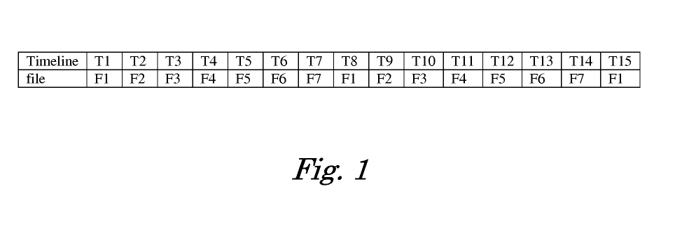

FIG. 1 describes a situation where the recorded video stream is divided into different parts while recording. The recording tool uses the files in loop order. We may consider the following three flow options:

Flow A—Basic, Selected Parts are Taken from the Loops:
1. User start recording a video stream. The recorded data is saved in parts (as described above).
2. During the time T7 part F7 was recorded, the user marked “retroactive recording” from a time that is within part T6 of the stream
3. The user marked “end of scene” during parts T9.
4. Due to these marks T6, T7, T8 & T9 are taken out of the loop.
5. After all the space for saving was used, the loop is repeated but without the above 4 parts.
6. The user may mark additional scenes (steps 2-4) during the same loop run or during another loop run, and not all the time mark must be retroactive.
7. The recording is ended due to a user request, or due to too short a recording loop (after all parts that intersect with the marked timeline were excluded from the loop).
8. At the end of the recording, the user has the content which he marked for recording, since it was not overlapped by newer data.

### Flow B—Fixed Loop Length:

1. The user starts recording a video stream. The recorded data is saved in parts (as described above).
2. During the time T7 part F7 was recorded, the user marked “retroactive recording” from a time that is within part T6 of the stream.
3. The user marked “end of scene” during part T9.
4. Due to these marks, T6, T7, T8 & T9 are taken out of the loop.
5. The system allocates new 4 parts for the loop to replace the saved parts.
6. After all the space parts are used, the loop is repeated but this time it uses the new allocated parts.
7. The user may mark additional scenes (steps 2-5) during the same loop run or during another loop run, and not all time-marks must be retroactive.
8. The recording is ended due to a user request or because no new parts are available for allocation, when the loop is too short.
9. At the end of the recording, the user has the content which he marked for recording, since it was not overlapped by newer data, or by the recording loop.
   Flow C: Implementation with Multi Level Priorities (Assume Two Levels of Priority: Highest and Medium)
1. The user start recording a video stream. The recorded data is saved in parts (as described above).
2. During the time T7 part F7 was recorded, the user marked “retroactive recording” from a time that is within part T6 of the stream and gave it the highest priority.
3. The user marked “end of scene” during part T9.
4. Due to these marks, T6, T7, T8 & T9 are taken out of the loop.
5. The system does not allocate new parts in their stead.
6. The user continues to mark parts, marking some with highest priority and some with medium priority.
7. After marking the last highest priority scene, the loop is empty.
8. The system may send a warning to the user.
9. The system returns parts that were marked with medium priority back to the loop and its data is overwritten.
10. The recording is ended due to a user request or due to too short a loop, when there are no available new parts with priority other than highest for overwrite.
11. At the end of the recording, the user has the content which he marked as being with highest priority; lower priority segments were saved only if they were not overwritten by higher priority or the loop.

As will be understood by the skilled person, the loop represents data with lowest priority, so that flow A and B represent scenes where there are only two priority levels. Furthermore, the user can mark “start scenes” retroactively, but this is not mandatory.

The number and length of the saved files is relative to the following constraints:
if the user marks a period of time for retroactive action, all of the files included within that time should be saved and excluded from participating in future loop file saving.
the above also applies to still images and to all interesting sequence.
the single file length should be short since the longer the file length the smaller the flexibility of the editing process.

All the above description of preferred embodiments has been provided for the purpose of illustration and is not intended to limit the invention in any way. Many modifications can be carried out to the above, without exceeding the scope of the invention.

1. A digitally-enabled cellular phone device, provided with video recording means, comprising inputs means for recording a first mark relative to the video timeline, said first mark being indicative of the starting period of a segment of video to be assigned a priority value, and means for recording a second mark relative to said video timeline, said second mark being indicative of the end period of said segment of video.

2. A cellular phone device according to claim 1, further comprising means for prioritizing a plurality of video streams or frames taken therefrom.

3. A cellular phone device according to claim 1, comprising input means for recording a mark relative to the video timeline, said mark being indicative of at least one frame to be extracted from said stream of video.

4. A cellular phone device according to claim 1, wherein the mark added to the timeline identifies a frame or a number of frames to be used to generate a still image.

5. A cellular phone device according to claim 4, wherein the mark added to the timeline indicates an “immediate” image take.

6. A cellular phone device according to claim 4, wherein the mark added to the timeline indicates a “predefined delay”, suitable to identify a still image to be taken, which was recorded at a predetermined time before said mark was added.
